(19) United States
(12) Patent Application Publication
(10) Pub. No.: US 2016/0071466 A1
(43) Pub. Date: Mar. 10, 2016

(54) METHOD FOR CONTROLLING A DISPLAY

(71) Applicant: ROYOLE CORPORATION, Fremont, CA (US)

(72) Inventor: Zihong LIU, Fremont, CA (US)

(73) Assignee: ROYOLE CORPORATION

(21) Appl. No.: 14/681,785

(22) Filed: Apr. 8, 2015

Related U.S. Application Data
(60) Provisional application No. 62/046,887, filed on Sep. 5, 2014.

(51) Int. Cl. G09G 3/34; G09G 3/32

(52) U.S. Cl. CPC G09G 3/3406; G09G 3/3208; G09G 2330/023; G09G 2330/026

(57) ABSTRACT

A method for controlling a display screen includes receiving information to be displayed on the display screen, determining a required display area that is needed to display the information according to the information, and controlling the display screen to partially power on according to the required display area.

### CROSS-REFERENCE TO RELATED APPLICATIONS

This application is based upon and claims the benefit of priority from Provisional Application No. 62/046,887, filed on Sep. 5, 2014, the entire contents of which are incorporated herein by reference.

### TECHNOLOGY FIELD

The disclosure relates to a method for controlling a display and, more particularly, to a method for controlling a display to partially power on.

### BACKGROUND

With the development of mobile technology, mobile devices, such as smart phones or tablets, have become more and more important in people's daily life. A mobile device is usually powered by a built-in battery. Due to the nature of the mobile device, the capacity of the built-in battery is often compromised to, for example, achieve better mobility. Therefore, power consumption needs to be taken into consideration when designing a mobile device.

A mobile device is equipped with a display screen to display information or contents. Usually, a fair amount of power is consumed by the display screen. Sometimes, for example, the display screen may consume about 70%-80% of the total power of the mobile device. Therefore, a battery life of the mobile device is often affected by the display screen. In the conventional technology, when the mobile device needs to display a piece of information or certain contents, the entire display screen needs to be powered on. Sometimes, the information or content that needs to be displayed only occupies a small portion of the display screen, and thus the rest of the display screen is not utilized but still consumes power. As a result, a lot of power is wasted, and the battery life of the mobile device is reduced.

To reduce the power consumption by a display screen, a mobile device may provide an option to reduce the brightness of the entire display screen. However, reducing the brightness may also reduce the readability of the contents displayed on the display screen, and thus affects the user experience.

### SUMMARY

In accordance with the disclosure, there is provided a method for controlling a display screen. The method includes receiving information to be displayed on the display screen, determining a required display area that is needed to display the information according to the information, and controlling the display screen to partially power on according to the required display area.

Also in accordance with the disclosure, there is provided an electronic device. The electronic device includes a display screen and a controller. The controller is configured to receive information to be displayed on the display screen, determine, according to the information, a required display area that is needed to display the information, and control the display screen to partially power on according to the required display area.

Features and advantages consistent with the disclosure will be set forth in part in the description which follows, and in part will be obvious from the description, or may be learned by practice of the disclosure. Such features and advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1A schematically shows a mobile device according to an exemplary embodiment.

FIG. 1B schematically shows a portion of a control logic of the mobile device according to an exemplary embodiment.

FIG. 2 is a flow chart showing a method according to an exemplary embodiment.

FIGS. 3A and 3B schematically show states of the mobile device when a display screen of the mobile device is partially turned on according to exemplary embodiments.

FIG. 4A schematically shows a backlight panel in an LCD display screen according to an exemplary embodiment.

FIG. 4B schematically shows a backlight panel in an LCD display screen according to another exemplary embodiment.

FIG. 4C schematically shows an LCD panel in the LCD display screen according to an exemplary embodiment.

FIG. 5A schematically shows an organic light-emitting diode (OLED) panel in an active-matrix OLED (AMOLED) display screen according to an exemplary embodiment.

FIG. 5B schematically shows an AMOLED unit according to another exemplary embodiment.

FIG. 6 schematically shows an e-ink panel in an e-ink display screen according to an exemplary embodiment.

### DESCRIPTION OF THE EMBODIMENTS

Embodiments consistent with the disclosure include a method for controlling a display to partially power on.

Hereinafter, embodiments consistent with the disclosure will be described with reference to the drawings. Wherever possible, the same reference numbers will be used throughout the drawings to refer to the same or like parts.

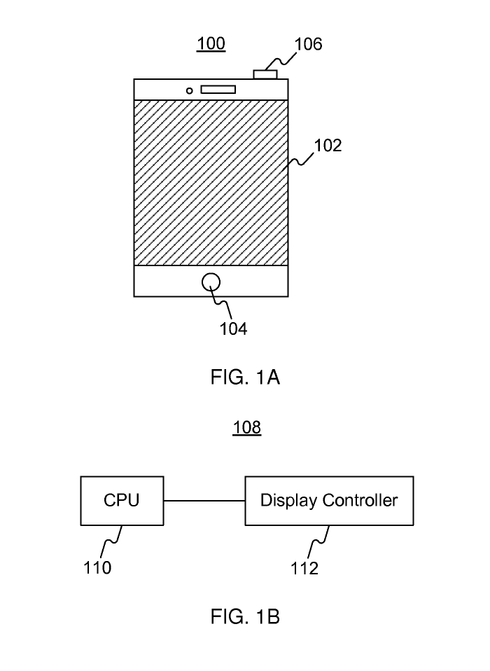

FIG. 1A schematically shows a mobile device 100 consistent with embodiments of the present disclosure. The mobile device 100 includes a display screen 102, a control button 104, and a power button 106.

The display screen 102 is configured to display information or contents, and may be, for example, an LCD screen, an organic light-emitting diode (OLED) (such as a passive-matrix OLED (PMOLED) or an active-matrix OLED (AMOLED)) screen, or an e-ink screen. In some embodiments, the display screen 102 includes a touch screen. The display screen 102 may be turned on and off manually, and may automatically enter into an off state from an on state when the mobile device 100 has been idle for a certain period of time.

The control button 104 may be a mechanical button. A user may press on the control button 104 to input a control command, such as turning on the display screen 102, to the mobile device 100. In some embodiments, the control button 104 may include a touch sensor, configured to generate the control command when sensing a touch. The control button 104 may include other sensors to receive various signals. In some embodiments, a finger-print reader may be integrated in the control button 104.

The power button 106 is configured to turn on and off the mobile device 100. For example, the mobile device 100 may be turned on and off by pressing and holding the power button 106 for a certain period of time. In some embodiments, a single pressing on the power button 106 may also turn on and off the display screen 102.

FIG. 1B schematically shows a portion of a control logic 108 of the mobile device 100. The control logic 108 may include, as shown in FIG. 1B, a central processing unit (CPU) 110 and a display controller 112, which may be a function unit of the CPU 110 or a separate integrated circuit coupled between the CPU 110 and the display screen 102. Consistent with embodiments of the disclosure, the CPU 110 controls an overall operation of the mobile device 100, while the display controller 112 controls an operation of the display screen 102. For example, the display controller 112 controls the display screen 102 to turn on and off, and/or controls what contents are displayed on the display screen 102 and how they are displayed. In some embodiments, the display screen 102 includes a touch screen. In this scenario, the display controller 112 may also operate to process touching signals from the touch screen and generate corresponding instructions.

The display controller 112 may include various control units that control different components of the display screen. For example, the display screen 102 includes a plurality of display units arranged in an array, each of which may be individually controlled to turn on and off. By controlling the on and off of the display units and the amount of light emitting from the display units, an image can be displayed. To control the display units, the display controller 112 may include a timing control unit that generates control signals to be applied to the display units. In some embodiments, the display units of the display screen 102 do not generate light themselves, but rather can allow light to pass through. In this scenario, the display screen 102 also includes a backlight panel for generating light, and the display controller 112 further includes a backlight control unit to control the operation of the backlight panel.

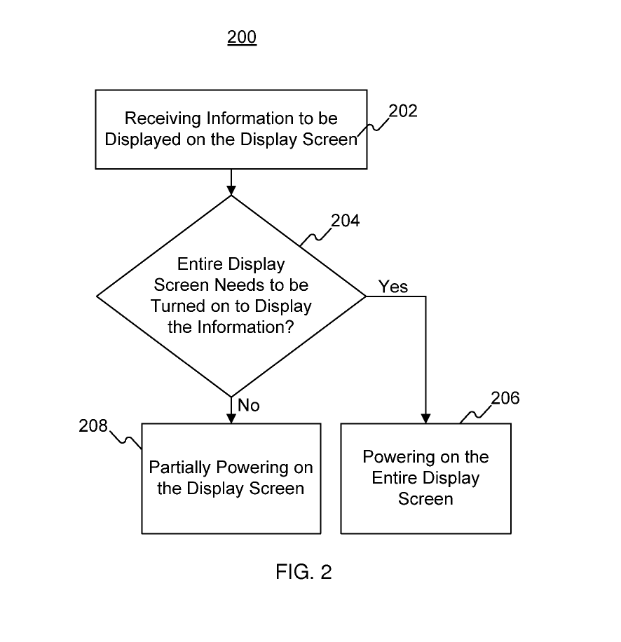

FIG. 2 is a flow chart showing an exemplary method 200 consistent with embodiments of the present disclosure for controlling a display screen, such as the display screen 102 in the mobile device 100. As shown in FIG. 2, at 202, the mobile device 100 receives a piece of information to be displayed on the display screen 102. The information may be carried in a triggering signal received by the mobile device 100. Alternatively, the information may be previously stored in a storage medium and the triggering signal instructs the mobile device 100 to display the pre-stored information. At 204, the mobile device 100 determines whether the entire display screen 102 needs to be turned on according to the information. That is, the mobile device 100 determines a required display area that is needed for displaying the information, and determines whether the required display area would occupy the entire display screen 102. If the entire display screen 102 is needed for displaying the information (204: “Yes”), the entire display screen 102 is turned on (206 in FIG. 2), i.e., the mobile device 100 controls the display screen 102 to fully power on. Otherwise (204: “No”), only a portion of the display screen 102 that is needed to display the information is turned on (208 in FIG. 2), i.e., the mobile device 100 controls the display screen 102 to partially power on.

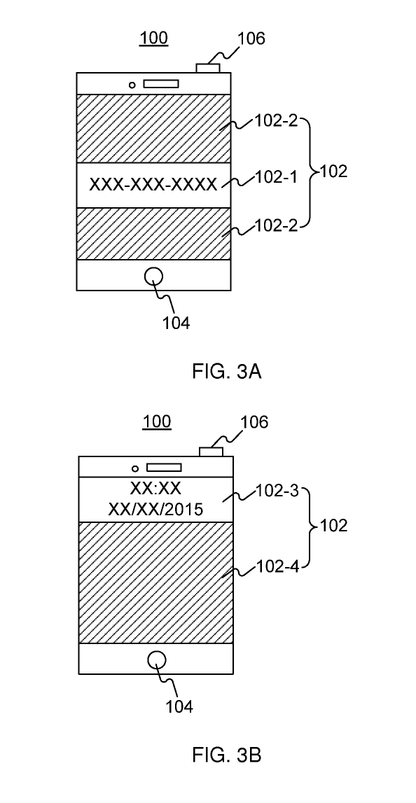

Consistent with the present disclosure, whether the entire display screen 102 needs to be turned on may depend on how much display area is needed to display the information. For example, when the mobile device 100 receives an incoming call while the display screen 102 is in the off state, besides outputting a ringing or vibration, the mobile device 100 may also need to display at least one of a phone number or a contact name that is associated with the incoming call on the display screen 102. That is, the mobile device 100 receives a triggering signal to display a piece of information—at least one of the phone number or the contact name. The mobile device 100 determines that only a small portion, such as about 10% or even less, of the entire display screen 102 is needed to display the phone number and/or the contact name. As a result, only the portion of the display screen 102 that is needed to display the phone number and/or contact name is turned on to display such information to the user. The rest of the display screen 102 is kept off. FIG. 3A schematically illustrates this scenario, in which one portion 102-1 of the display screen 102 is turned on to display the phone number and/or contact name, and other portions 102-2 of the display screen 102 are kept off to save power.

In the example described above, an incoming call is used as an example of an event that is independent of the user's concurrent operation. In the present disclosure, such an event is also referred to as a “passive event.” Besides the incoming call, the passive event may also be, for example, an incoming text message, a calendar reminder, or a notification message from an app installed on the mobile device 100.

Besides the passive event, an active event may also trigger the partially turning on of the display screen 102. In the present disclosure, an active event refers to an event resulting from the user's operation. Different predetermined information may be associated with different user operations. For example, when the user press on the control button 104 or the power button 106 for one time while the display screen 102 is in the off state, the mobile device 100 determines that a piece of predetermined information, such as time, a virtual key pad, a sliding bar for turning on the mobile device, needs to be displayed according to this operation. Thus, as shown in FIG. 3B, one portion 102-3 is turned on to display the predetermined information, while the other portion 102-4 is kept off to save power.

Consistent with the present disclosure, the CPU 110 receives and analyzes the information. According to the information, the CPU 110 generates a CPU signal and sends it to the display controller 112, which then controls the operation of the display screen 102 according to the CPU signal.

In some embodiments, the display screen 102 includes a backlight-lit LCD, such as a light-emitting diode (LED) lit LCD. In such a display screen, backlight sources, such as LEDs, may be arranged as an array behind an LCD panel. Liquid-crystal (LC) cells in the LCD panel can be turned on and off to allow light to pass through or prevent light from passing through. In this scenario, the display controller 112 includes the backlight control unit configured to individually control the backlight sources. That is, instead of turning on and off all the backlight sources simultaneously, the backlight control unit may be configured to turn on and off each individual backlight source separately. In some embodiments, the backlight sources may be divided into several groups, each of which includes multiple backlight sources. The backlight control unit may also be configured to turn on and off each individual group separately.

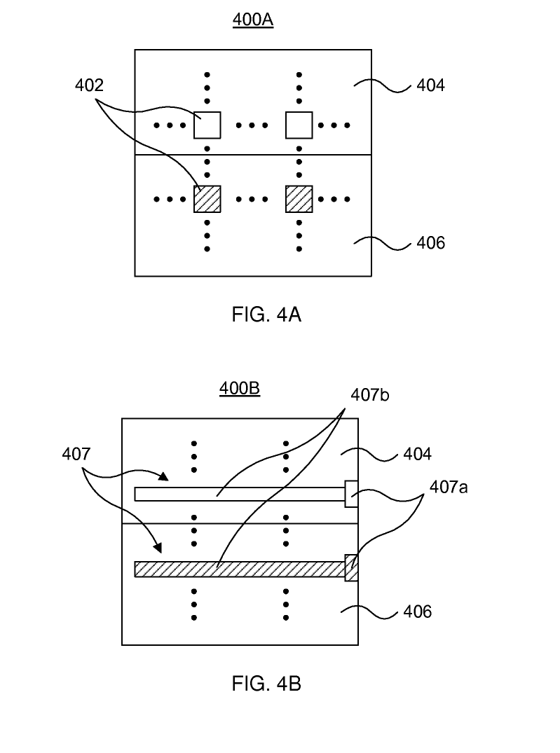

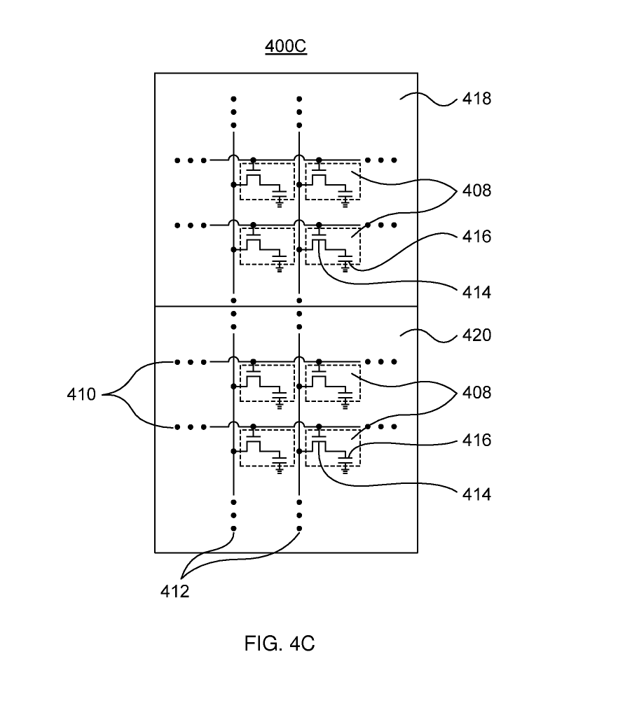

FIG. 4A schematically shows an exemplary backlight panel 400A consistent with embodiments of the present disclosure. The backlight panel 400A may be installed in the display screen 102 when the display screen 102 includes an LCD display screen. The backlight panel 400A is positioned behind an LCD panel (not shown in FIG. 4A) and includes a plurality of backlight units 402 arranged in an array. Each backlight unit 402 can be separately controlled by the backlight control unit, and may include one or more backlight resources, such as LEDs.

FIG. 4B schematically shows another exemplary backlight panel 400B consistent with embodiments of the present disclosure. The backlight panel 400B is similar to the backlight panel 400A, except that the backlight panel 400B includes a plurality of backlight units 407 arranged in a row, instead of the backlight units 402 arranged in an array. The backlight panel 400B may also be installed in the display screen 102 when the display screen 102 includes an LCD display screen, and be positioned behind an LCD panel (not shown in FIG. 4A). Each backlight unit 407 includes one or more backlight resources 407a, such as LEDs, and one or more waveguides 407b. The backlight resources 407a may be arranged at one or more edges of the backlight panel 400B. The waveguides 407b convey the light emitted by the backlight resources 407a to the entire backlight panel 400B. Similar to the backlight units 402, each of the backlight units 407 can be separately controlled by the backlight control unit.

Consistent with the present disclosure, according to the controlling signal from the CPU 110, the backlight control unit operates to turn on the backlight sources of the backlight units (the backlight units 402 in FIG. 4A or the backlight units 407 in FIG. 4B) in a first portion 404 of the backlight panel (the backlight panel 400A in FIG. 4A or the backlight panel 400B in FIG. 4B), and keep off the backlight sources of the backlight units in a second portion 406 of the backlight panel. The first portion 404 corresponds to the portion of the display screen 102 that needs to be turned on to display information, such as the portion 102-1 in FIG. 3A or the portion 102-3 in FIG. 3B. The second portion 406 corresponds to the portion of the display screen 102 that does not need to be turned on, such as the portion 102-2 in FIG. 3A or the portion 102-4 in FIG. 3B.

In an LCD display, each LC cell in the LCD panel may be controlled by one or more thin-film transistors (TFTs). In some embodiments, instead of or in addition to partially turning on the backlight sources, the display controller 112 may also control to partially turn on the LC cells by individually controlling the on and off of the TFTs.

FIG. 4C schematically shows an exemplary LCD panel 400C consistent with embodiments of the present disclosure. The LCD panel 400C may be installed in the display screen 102 when the display screen 102 includes an LCD display screen. The LCD panel 400C is positioned in front of a backlight panel (not shown in FIG. 4C) and includes a plurality of LCD units 408 arranged in an array. Each LCD unit 408 is coupled between a scan line 410 and a data line 412, and includes a TFT 414 coupled to an LC cell 416. By applying various signals to the scan lines 410 and the data lines 412, the display controller 112 can control the on and off of the TFTs 414, and thus the on and off of the LC cells 416. Such various signals can be generated by the timing control unit in the display controller 112.

According to the present disclosure, the LCD panel 400C may include additional components not shown in FIG. 4C. For example, each LCD unit 408 may further include a compensation circuit.

Consistent with the present disclosure, according to the controlling signal from the CPU 110, the timing control unit operates to only provide signals to the TFTs 414 in a first portion 418 of the LCD panel 400C but not the TFTs 414 in a second portion 420 of the LCD panel 400C. As such, the LC cells 416 in the first portion 418 of the LCD panel 400C are turned on while the LC cells 416 in the second portion 420 of the LCD panel 400C are kept off. The first portion 418 of the LCD panel 400C corresponds to the portion of the display screen 102 that needs to be turned on to display information, such as the portion 102-1 in FIG. 3A or the portion 102-3 in FIG. 3B. The second portion 420 of the LCD panel 400C corresponds to the portion of the display screen 102 that does not need to be turned on, such as the portion 102-2 in FIG. 3A or the portion 102-4 in FIG. 3B.

The above scheme of partially turning on LC cells applies to an LCD display screen that does not have a plurality of backlight sources, an LCD display screen having backlight source(s) arranged at one or more sides of the LCD panel, or an LCD display screen having backlight sources arranged in an array across the LCD panel. Since turning on an LC cell may require applying a voltage across the LC cell and thus consumes power, keeping off the LC cells that are not needed for displaying information also reduces the power consumption by the display screen 102.

In some embodiments, the display screen 102 includes an AMOLED panel. An AMOLED panel includes a plurality of OLEDs arranged in an array. Each OLED can be individually controlled to emit light.

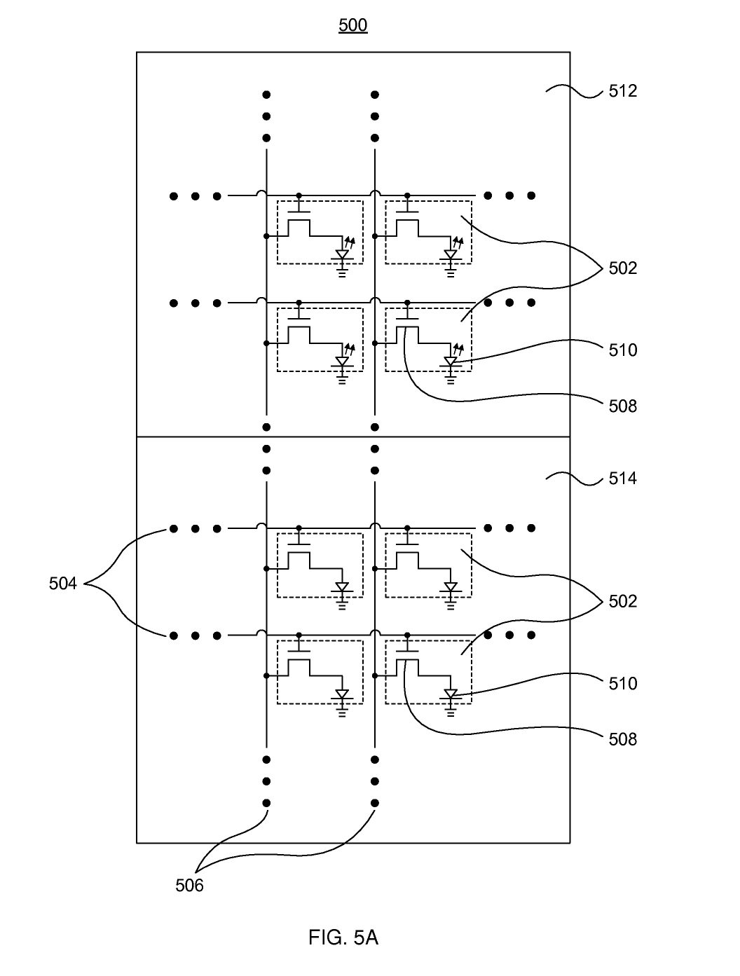

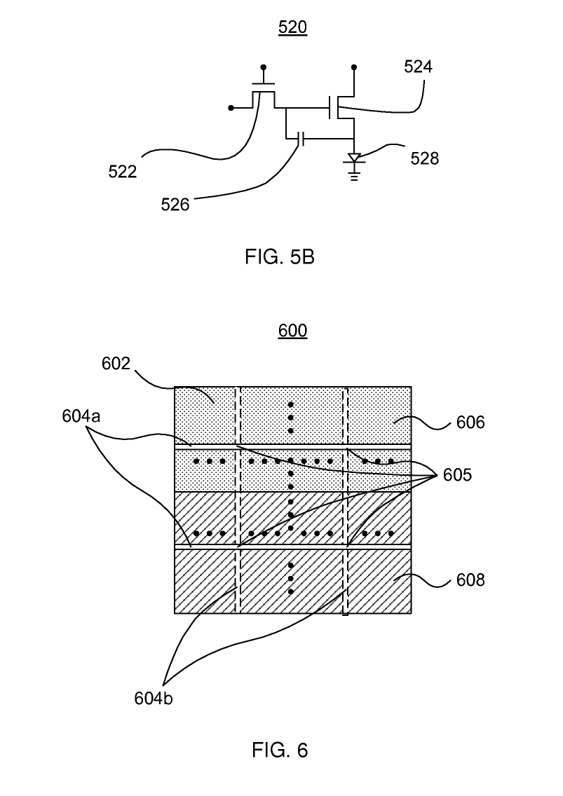

FIG. 5A schematically shows an exemplary AMOLED panel 500 consistent with embodiments of the present disclosure. The AMOLED panel 500 may be installed in the display screen 102 when the display screen 102 includes an AMOLED display screen. The AMOLED panel 500 includes a plurality of AMOLED units 502 arranged in an array. Each AMOLED unit 502 is coupled between a scan line 504 and a data line 506, and includes a TFT 508 and an OLED 510. By applying various signals to the scan lines 504 and the data line 506, the display controller 112 can control the on and off of the TFTs 508 individually, and thus control the on and off of the OLEDs 510 individually. Such various signals can be generated by the timing control unit in the display controller 112.

Consistent with the present disclosure, according to the controlling signal from the CPU 110, the timing control unit operates to provide signals to the TFTs 508 in a first portion 512 of the AMOLED panel 500, but not the TFTs 508 in a second portion 514 of the AMOLED panel 500. As such, the OLEDs 510 in the first portion 512 of the AMOLED panel 500 are turned on, while the OLEDs 510 in the second portion 514 of the AMOLED panel 500 are kept off. The first portion 512 of the AMOLED panel 500 corresponds to the portion of the display screen 102 that needs to be turned on to display information, such as the portion 102-1 in FIG. 3A or the portion 102-3 in FIG. 3B. The second portion 514 of the AMOLED panel 500 corresponds to the portion of the display screen 102 that does not need to be turned on, such as the portion 102-2 in FIG. 3A or the portion 102-4 in FIG. 3B.

It is noted that the AMOLED units 502 shown in FIG. 5A are a simplified example of AMOLED units. The AMOLED units according to the present disclosure may have a more complex structure. For example, FIG. 5B schematically shows another exemplary AMOLED unit 520. The AMOLED unit 520 includes a first TFT 522, a second TFT 524, a capacitor 526, and an OLED 528. In some embodiments, the AMOLED unit may have more than one capacitor, and may also have a compensation circuit.

In some embodiments, the display screen 102 includes an e-ink panel. An e-ink panel includes a plurality of pixels arranged in an array. Each pixel can be individually controlled to reflect light of different colors.

FIG. 6 schematically shows an exemplary e-ink panel 600 consistent with embodiments of the present disclosure. The e-ink panel 600 may be installed in the display screen 102 when the display screen 102 includes an e-ink display screen. The e-ink panel 600 includes a plurality of particles 602 dispersed between two plates (not shown). In some embodiments, each particle 602 has different color on different sides, with different sides facing up (such as the direction perpendicular to the drawing sheet) when different electric fields are applied so that different colors can be displayed. In some embodiments, the particles 602 float in a liquid filled between the two plates, and migrate to one of the two plates depending on the applied field so that different colors can be displayed.

As shown in FIG. 6, the e-ink panel 600 further includes a plurality of first electrodes 604a and a plurality of second electrodes 604b arranged crossing each other. Cross-points 605 between the first and the second electrodes 604 constitute pixels of the e-ink panel 600. By applying various signals to the first and second electrodes 604a and 604b, the display controller 112 can individually control the electric field, and thus the color, at each cross-point 605. Such various signals can be generated by the timing control unit in the display controller 112.

Consistent with the present disclosure, according to the controlling signal from the CPU 110, the display controller 112 operates to apply voltages to the electrodes in a first portion 606 of the e-ink panel 600, and not to the electrodes in a second portion 608 of the e-ink panel 600. The first portion 606 corresponds to the portion of the display screen 102 that needs to be turned on to display information, such as the portion 102-1 in FIG. 3A or the portion 102-3 in FIG. 3B. The second portion 608 corresponds to the portion of the display screen 102 that does not need to be turned on, such as the portion 102-2 in FIG. 3A or the portion 102-4 in FIG. 3B.

It is noted that the e-ink panel 600 shown in FIG. 6 is for illustration purpose only. An e-ink panel consistent with the present disclosure may have a more complicated structure. For example, TFTs may be employed in the e-ink panel to control the electric field at the pixels.

Consistent with the present disclosure, the mobile device 100 may also include a non-transitory computer-readable storage medium, such as a memory, that stores data for supporting the operation of the mobile device 100. The storage medium is coupled to the CPU 110 and/or the display controller 112, and stores instructions that cause the mobile device 100 to, for example, operate in consistence with embodiments of the present disclosure. For example, the instructions may cause the CPU 110 and/or the display controller 112 to execute methods consistent with embodiments of the present disclosure, such as those described above. The storage medium may include, for example, a volatile or a non-volatile memory device, or a combination thereof, such as a static random access memory (SRAM), a read-only memory (ROM), a programmable read-only memory (PROM), an erasable programmable read-only memory (EPROM), an electrically erasable programmable read-only memory (EEPROM), a magnetic memory, a flash memory, or a magnetic or optical disk.

Other embodiments of the present disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for controlling a display screen, comprising:
receiving information to be displayed on the display screen;
determining, according to the information, a required display area that is needed to display the information; and
controlling the display screen to partially power on according to the required display area.

2. The method of claim 1, wherein controlling the display screen to partially power on includes powering on a first portion of the display screen that corresponds to the required display area and keeping off a second portion of the display screen that does not correspond to the required display area.

3. The method of claim 1, wherein:
the display screen includes:
an active-matrix organic light-emitting diode panel including a plurality of organic light-emitting diodes (OLEDs) arranged in an array, and
controlling the display screen to partially power on includes turning on a portion of the OLEDs that correspond to the required display area while keeping other OLEDs off.

4. The method of claim 1, wherein:
the display screen includes:
a plurality of backlight sources arranged in an array; and
a liquid-crystal display (LCD) panel arranged in front of the backlight sources, and
controlling the display screen to partially power on includes turning on a portion of the backlight sources that correspond to the required display area while keeping other backlight sources off.

5. The method of claim 4, wherein:
the LCD panel includes:
a plurality of liquid-crystal (LC) cells arranged in an array, and
controlling the display screen to partially power on further includes turning on a portion of the LC cells that correspond to the required display area while keeping other LC cells off.

6. The method of claim 1, wherein:
the display screen includes:
a liquid-crystal panel including a plurality of liquid-crystal (LC) cells arranged in an array, and
controlling the display screen to partially power on includes turning on a portion of the LC cells that correspond to the required display area while keeping other LC cells off.

7. The method of claim 1, wherein:
the display screen includes:
an e-ink panel including electrodes for controlling the e-ink panel to display information, and
controlling the display screen to partially power on includes applying voltages to a portion of the electrodes that correspond to the required display area without applying voltages to other electrodes.

8. The method of claim 1, wherein:
the display screen is installed on a mobile device, and
receiving the information to be displayed includes receiving a triggering signal to display at least one of a phone number or a contact name when the mobile device receives an incoming phone call.

9. The method of claim 1, wherein:
the display screen is installed on a mobile device, and
receiving the information to be displayed includes receiving a triggering signal to display a text message when the mobile device receives the text message.

10. The method of claim 1, wherein:
the display screen is installed on a mobile device, and
receiving the information to be displayed includes receiving a triggering signal to display a notification generated by an app installed on the mobile device.

11. The method of claim 1, wherein:
the display screen is installed on a mobile device, and
receiving the information to be displayed includes receiving a triggering signal to display predetermined information associated with an operation by a user on the mobile device.

12. An electronic device, comprising:
a display screen; and
a controller configured to:
receive information to be displayed on the display screen;
determine, according to the information, a required display area that is needed to display the information; and
control the display screen to partially power on according to the required display area.

13. The electronic device of claim 12, wherein:
the display screen includes an active-matrix organic light-emitting diode panel including a plurality of organic light-emitting diodes (OLEDs) arranged in an array, and
the controller is further configured to turn on a portion of the OLEDs that correspond to the required display area while keep other OLEDs off.

14. The electronic device of claim 12, wherein:
the display screen includes:
a plurality of backlight sources arranged in an array; and
a liquid-crystal display (LCD) panel arranged in front of the backlight sources, and
the controller is further configured to turn on a portion of the backlight sources that correspond to the required display area while keep other backlight sources off.

15. The electronic device of claim 14, wherein:
the LCD panel includes:
a plurality of liquid-crystal (LC) cells arranged in an array, and
the controller is further configured to turn on a portion of the LC cells that correspond to the required display area while keep other LC cells off.

16. The electronic device of claim 12, wherein:
the display screen includes:
a liquid-crystal panel including a plurality of liquid-crystal (LC) cells arranged in an array, and
the controller is further configured to turn on a portion of the LC cells that correspond to the required display area while keep other LC cells off.

17. The electronic device of claim 12, wherein:
the display screen includes:
an e-ink panel including electrodes for controlling the e-ink panel to display information, and
the controller is further configured to apply voltages to a portion of the electrodes that correspond to the required display area without applying voltages to other electrodes.
